(19) United States
(12) Patent Application Publication
(10) Pub. No.: US 2010/0157876 A1
(43) Pub. Date: Jun. 24, 2010

(54) METHOD FOR SELECTIVE TRANSMITTING/RECEIVING ANTENNA REPETITION

(75) Inventors: Young Seog SONG, Daejeon (KR); Dong Seung Kwon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/603,675

(22) Filed: Oct. 22, 2009

(30) Foreign Application Priority Data
Dec. 18, 2008 (KR) 10-2008-0129451

(51) Int. Cl. H04B 7/14

(52) U.S. Cl. 370/315

(57) ABSTRACT

Disclosed is a method for selective transmitting/receiving antennal repetition. A repeater performs wireless communication with a terminal located in a jurisdiction repetition area by using one transmitting/receiving antenna, and communicates with a base station by using multiple transmitting/receiving antennas. The repeater, in a downlink, selectively receives a signal transmitted from a specific transmitting antenna of the base station by using a signal process technology, and amplifies and transmits the signal to the repetition area. Further, in an uplink, the repeater receives a signal received from the terminal in the repetition area and then transmits the signal to the base station. In this operation, the signal transmitted to the base station is processed by the repeater such that a specific receiving antenna the base station can receive the signal with the largest strength.

### CROSS-REFERENCE TO RELATED APPLICATION

This application claims priority to and the benefit of Korean Patent Application No. 10-2008-0129451 filed in the Korean Intellectual Property Office on Dec. 18, 2008, the entire contents of which are incorporated herein by reference.

### BACKGROUND OF THE INVENTION

(a) Field of the Invention

The present invention relates to a method for selective transmitting/receiving antennal repetition. In particular, the present invention relates to a repetition method for implementing spatial division multiplexing access and a method of acquiring area information of a terminal.

(b) Description of the Related Art

Technologies for improving sector throughput by using multiple antennas have been researched in the wireless transmission technology. Spatial division multiplexing access (hereafter referred to as “SDM”) technology in various technologies for improving sector throughput is a method of acquiring a multiplexing gain by transmitting different signals to a plurality of antennas.

Further, in recent years, a precoding SDM technology that crosses multiple antennas or creates a plurality of beams, which hardly interfere with each other and carry data streams on the beams and transmit them, has been widely used as a technology that increases capacity. SDM or the precoding SDM technology makes it possible to transmit several streams to one terminal or simultaneously transmit data streams to several terminals. This technology is called spatial division multiplexing access (referred to as “SDMA” hereafter) or precoding SDMA. The SDMA method or the precoding SDMA method can be applied when transmitting a data stream to a terminal through a downlink or receiving a data stream from a terminal through an uplink.

In order to acquire the maximum transmission gain from the SDMA or the precoding SDMA, as many data streams as possible should be simultaneously transmitted, which is possible when the receiving signal-to-noise ratio (SNR) of the terminals involved in the multiple transmission is high.

In this operation, terminals located close to a base station have a high receiving signal-to-noise ratio (SNR) such that it is easy to apply the SDMA method, whereas the receiving signal-to-noise ratio (SNR) of terminals located far away from the base station decreases, such that it is difficult to apply the SDMA method. Therefore, a base station can use the SDMA method only at some areas (areas close to the base station) in a cell, such that is not adequate for the original object of increasing the sector capacity.

On the other hand, a repeater is used in mobile communication systems to remove a shadow area in a cell or enlarge coverage. A repeater disposed in a shadow area removes the shadow area by improving the receiving signal-to-noise ratio (SNR), and a repeater disposed outside the cell radius area of the base station enlarges the coverage of the base station.

Use of a repeater to apply the SDMA method has been proposed in the related art. However, since using a wire optic repeater to apply the SDMA method in the related art requires an optical line between a base station and a repeater, the operator needs to pay additional cost, such as rent for the optical line, in addition to the setup cost of the repeater. Further, when a repeater is used to apply the SDMA method, a terminal checks the repetition area to which the terminal itself pertains by using a pilot signal of a downlink and feeds it back to the base station in order to transmit information on the repetition area to which the terminal itself pertains to a base station, such that additional feedback overhead is generated in the uplink.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for selective transmitting/receiving antennal repetition having advantages of reducing feedback overhead that is generated when a terminal determines and feeds back a repetition area, and efficiently using an SDMA method without additional expenses.

An exemplary embodiment of the present invention provides a method for a repeater to repeat a signal transmitted from a base station including a plurality of transmitting antennas in a downlink by using a spatial division multiplexing access method, including: estimating channel values of the downlink by using downlink signals received from the base station through a plurality of receiving antennas; calculating coefficient vectors for selecting one of the plurality of transmitting antennas by using the channel values; multiplying the downlink signals received by the plurality of receiving antennas by the coefficient vectors and outputting the results; outputting one signal by adding the down signals multiplied by the coefficient vectors; and amplifying the outputted signal and transmitting the same to a terminal located in a repetition area of the repeater.

Further, an exemplary embodiment of the present invention provides a method in which a repeater repeats a signal transmitted from a terminal in a corresponding repetition area to a base station including a plurality of receiving antennas in an uplink by using a spatial division multiplexing access method, including: calculating a coefficient vector for selecting one of the plurality of receiving antennas by using a channel value of the uplink; distributing the uplink signals received from the terminal to a plurality of transmitting/receiving antennas; multiplying the distributed signals by the coefficient vector and outputting the results; amplifying the signals multiplied by the coefficient vector; and transmitting the amplified signals to the base station by using the plurality of transmitting/receiving antennas.

Further, an exemplary embodiment of the present invention provides a method in which a base station including a plurality of receiving antennas acquires information on an area where a terminal is located to implement a spatial division multiplexing access method by using a repeater, including: directly receiving reference signals by the terminal through the plurality of receiving antennas, or receiving the reference signals amplified by a repeater; calculating receiving power for the plurality of receiving antennas by using the reference signals; and determining a repetition area or a base station area where the terminal is located by comparing the receiving power of the plurality of receiving antennas.

### BRIEF DESCRIPTION OF THE DRAWINGS

FIG. 1 is a diagram illustrating a mobile communication system according to an exemplary embodiment of the present invention.

FIG. 2 is a configuration diagram illustrating a repeater for a downlink according to an exemplary embodiment of the present invention.

FIG. 3 is a configuration diagram illustrating a repeater for an uplink according to an exemplary embodiment of the present invention.

FIG. 4 is a flowchart illustrating a method of acquiring information on an area where a terminal is located so that a base station according to an exemplary embodiment of the present invention applies an SDMA method.

FIG. 5 is a flowchart illustrating a method of repeating a signal transmitted from a base station by using a repeater for a downlink according to an exemplary embodiment of the present invention.

FIG. 6 is a flowchart illustrating a method of repeating a signal transmitted from a terminal by using a repeater for an uplink according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), and an access terminal (AT), etc., and may include the entire or partial functions of the mobile station, the mobile terminal, the subscriber station, the portable subscriber station, the user equipment, the access terminal, etc.

In the specification, a base station (BS) may designate an access point (AP), a radio access station (RAS), a node B, an evolved node-B (eNB), a base transceiver station (BTS), and a mobile multihop relay (MMR)-BS, etc., and may include the entire or partial functions of the access point, the radio access station, the node B, the eNB, the base transceiver station, the MMR-BS, etc.

A repetition method for implementing spatial division multiplexing access and a method of acquiring area information of a terminal according to an exemplary embodiment of the present invention are described hereafter in detail with reference to the accompanying drawings.

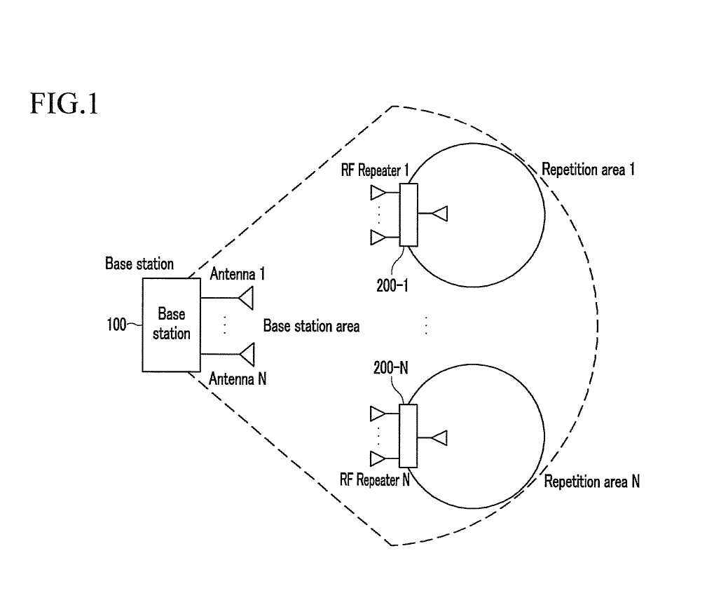

FIG. 1 is a diagram illustrating a mobile communication system according to an exemplary embodiment of the present invention, which is a configuration diagram illustrating a base station and a wireless repetition system using the SDMA method.

Referring to FIG. 1, a base station 100 includes N multiple transmitting/receiving antennas (antenna 1-antenna N), and a wireless repetition system includes N groups of repeaters. Further, one group of repeaters one-to-one corresponds to each antenna (antenna 1-antenna N) of the base station 100, and each group of repeaters includes one repeater (RF repeater 1. RF repeater N). Meanwhile, although FIG. 1 exemplifies each group of repeaters including one repeater, the present invention is not limited thereto, and the present invention can be applied to when each group of repeaters includes a plurality of repeaters.

In the downlink, the repeaters (200-1-200-N) selectively receive signals transmitted from specific transmitting antennas of the base station 100, using a signal processing technology, and amplify the received signals and transmit them to corresponding repetition areas. In this operation, signals transmitted from other transmitting antennas are maximally prevented.

Further, in the uplink, the repeaters (200-1-200-N) receive signals transmitted from terminals in corresponding repetition areas, amplify the received signals to allow specific receiving antennas of the base station 100 to receive signals having the largest strength, and transmit them to the base station 100.

Meanwhile, in an exemplary embodiment of the present invention, as shown in FIG. 1, the repeaters (200-1-200-N) are one-to-one connected with the transmitting antennas of the base station 100 and the base station 100 transmits different pilot signals for the transmitting antennas, such that the terminals located in the repetition areas of the repeaters (200-1-200-N) can discriminate the repetition areas where they are located.

A variety of methods can be used to allow the base station 100 to transmit pilot signals such that the pilot signals can be discriminated for the transmitting antennas. For example, the base station 100 can transmit pilot signals for the transmitting antennas at different times using a time division method, or can transmit pilot signals for the transmitting antennas at different frequencies using a frequency division method. Further, it is also possible to transmit pilot signals with different delay amounts for the transmitting antennas, using a cyclic delay diversity method. The pilot signals are not signals specifically created to be transmitted to the repeater (200-1-200-N) by the base station 100, but imply typical preamble signals or pilot signals included in data symbols.

In a multiple input multiple output (hereafter referred to as “MIMO”) system as shown in FIG. 1, a period where the base station transmits pilot signals to terminals by using a plurality of transmitting antennas when transmitting data symbols through a downlink is determined in advance, and the transmission power of the pilot signals is uniform. Accordingly, the terminals can recognize the repetition areas where they are located on the basis of average power of the pilot signals for the transmitting antennas of the base station 100 that they receive. That is, the terminals in each repetition area can recognize that they are located in the repetition areas of repeaters (200-1-200-N) connected to which transmitting antennas of the base station 100 by the transmission antenna that has transmitted a pilot signal having the largest power, by comparing the power of the pilot signals transmitted for the transmitting antennas of the base station 100. For example, a terminal located in the repetition area 1 receives a pilot signal that is transmitted from the transmitting antenna 1 of the base station 100 with the largest power, and a terminal located in the repetition area N receives a pilot signal that is transmitted from the transmitting antenna N of the base station 100 with the largest power.

Further, when a terminal is located in a base station area where a signal is received from a base station 100, not a repetition area where a signal is received from the repeaters (200-1-200-N), the terminal uniformly receives pilot signals with the same strength of power for the antennas, such that the terminal can recognize that it is located in the base station area, i.e., a non-repetition area.

As described above, the terminal that has recognized the repetition area or the base station area where it is located feeds back information on the area where it is located (information on the repetition area or information on the base station) to the base station 100, and the base station 100 can apply the SDMA method by using the information. The terminal can feed back the information on the area where it is located by using index information, which is defined in advance in system design, which does not limit the present invention. The present invention can enable a terminal to feedback the information of an area in a different method.

The base station 100 that has fed back the information on the repetition area or the base station area where the terminal is located from the terminal selects terminals that do not interfere with each other, that is, terminals to apply the SDMA method one by one in a plurality of terminals located in each repetition area, when transmitting data streams through the downlink. It is possible to simultaneously transmit different data streams to the selected terminals through the transmitting antennas, or to receive the data stream from the selected terminals and apply the SDMA method.

Meanwhile, in an exemplary embodiment of the present invention, as described above, other than the terminal feeding back the information on the area where it is located to the base station 100, the base station 100 can recognize the repetition area or the base station area where the corresponding terminal is located by using a reference signal that is received from the terminal through the uplink. The base station 100 directly receives a reference signal (e.g., a pilot signal, a ranging signal, a control channel signal, a traffic signal, etc.) that the terminal periodically or non-periodically transmits through the uplink from the terminal, or receives a reference signal of the terminal that has been amplified by a repeater. Further, it is possible to recognize the repetition area or the base station area where each terminal is located by using the reference signal.

That is, when the terminals transmit reference signals terminal are promised in advance with the base station 100, the base station 100 directly receives the reference signals from the terminals through a plurality of receiving antennas, or receives reference signals that have been amplified by the repeater. Further, the base station 100 calculates and compares receiving power of the reference signals received from the terminals for the plurality of receiving antennas. In addition, when the receiving power of a specific receiving antenna in the plurality of receiving antennas has a difference of more than a predetermined value from the receiving power of the other receiving antennas, the repetition area corresponding to the receiving antenna is determined as a repetition area where the terminal is located. On the contrary, when the differences of the receiving power of the receiving antennas are not large, it is determined that the corresponding terminal is located in the base station area.

For this, the repeaters (200-1-200-N) amplify and transmit the signals transmitted from corresponding repetition areas to the base station 100 such that specific antennas of the base station 100 can receive the signals with the largest strength.

Meanwhile, when the repeaters are wire optical repeaters, the base station 100 can recognize the base station area or the repetition area where the terminal is located, in the same method as described above. For this, wire optical repeaters should be independently connected one-to-one to the antennas of the base station 100.

In an exemplary embodiment of the present invention, as described above, when recognizing the repetition area or the base station area where a terminal is located, the base station 100 can itself determine the repetition area or the base station area where the terminal is located even if the terminal does not feed back the information on the area, such that it is possible to reduce feedback overhead of the uplink.

Meanwhile, in the uplink according to an exemplary embodiment of the present invention, the method in which the base station 100 determines the repetition area or the base station area where the terminal is located can be used together with a method in which the terminal feeds back the information on the area where it is located to the base station 100. When the two methods are used together, it is possible to obtain an effect of reducing the amount of feedback information of the terminal. Meanwhile, it is possible to determine whether to use the two methods together and the ratio of the two methods from system operation parameters in the design of the system.

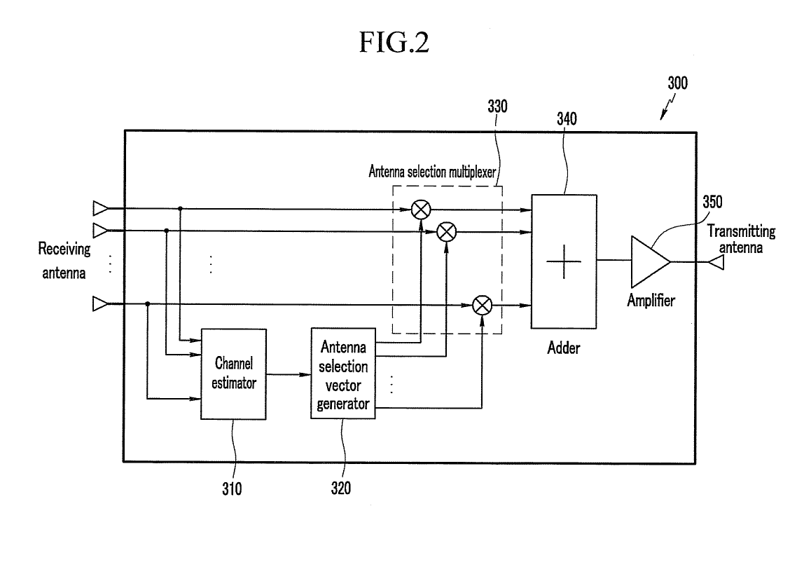

FIG. 2 is a diagram of a repeater 300 for a downlink according to an exemplary embodiment of the present invention.

Referring to FIG. 2, the repeater 300 for a downlink includes a plurality of receiving antennas, a channel estimator 310, an antenna selection vector generator 320, an antenna selection multiplier 330, an adder 340, an amplifier 350, and a transmitting antenna, and amplifies a signal of a corresponding transmitting antenna of the transmitting antennas of the base station 100 and transmits the signal to the terminal located in a corresponding repetition area. Signals transmitted from other transmitting antennas of the base station 100 are maximally prevented and processed.

When receiving the downlink signals transmitted from the base station 100 through the plurality of receiving antennas, the channel estimator 310 estimates the corresponding downlink MIMO channels and outputs the channel values.

The antenna selection vector generator 320 creates a coefficient vector for selecting the signal of a specific transmitting antenna, that is, for amplifying only the signal of a specific transmitting antenna and preventing signals of other transmitting antennas, on the basis of the channel values estimated by the channel estimator 310.

The antenna selection multiplier 330 outputs values obtained by multiplying each of the downlink signals received through the plurality of receiving antennas by the coefficient vector created by the antenna selection vector generator 320.

The adder 340 adds and outputs the signals outputted from the antenna selection multiplier 330, and the amplifier 350 amplifies the strength of the signals outputted from the adder 340 and then outputs the signals. The amplified signals are transmitted to the terminals located in the repetition area of the corresponding repeater 300 through one transmitting antenna.

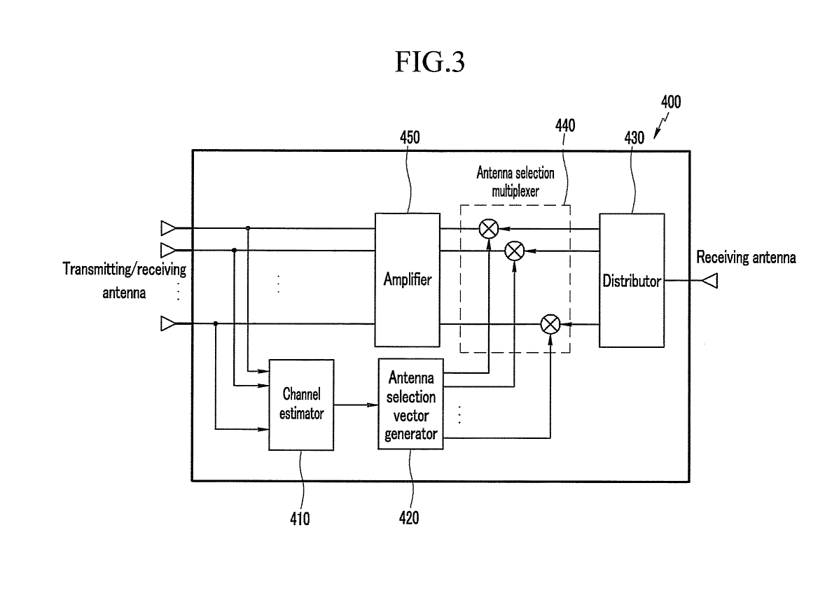

FIG. 3 is a configuration diagram illustrating a repeater 400 for an uplink according to an exemplary embodiment of the present invention, in which a repeater 400 in a time division duplex (hereafter referred to as “TDD”) system is exemplified.

Referring to FIG. 3, the repeater 400 for an uplink includes a plurality of transmitting/receiving antennas, a receiving antenna, a channel estimator 410, an antenna selection vector generator 420, a distributor 430, an antenna selection multiplier 440, and an amplifier 450, and amplifies signals received from the terminals in a corresponding repetition area and then transmits the signals to the base station 100. When the signals are transmitted to the base station 100, they are processed and transmitted such that specific antennas of the base station 100 can receive the signals with the largest strength.

The channel estimator 410 performs uplink MIMO channel estimation by using the downlink signals received through a plurality of transmitting/receiving antennas, and outputs channel values. The plurality of transmitting/receiving antenna receive downlink signals transmitted through the downlink from the base station 100 or transmit the uplink signals that will be transmitted from the repeater 400 through the uplink to the base station 100.

Meanwhile, in an exemplary embodiment of the present invention, the TDD system is exemplified to estimate the channel values by independently using the channel estimator 410; however, the present invention can be applied to a frequency division duplex (hereafter referred to as “FDD”) system. In this case, the repeater 400 receives the uplink MIMO channel values estimated by the base station 100 from the base station 100 through a channel receiving apparatus (not shown), and uses the values.

The antenna selection vector generator 420 creates a coefficient vector for selecting a specific receiving antenna in the receiving antennas of the base station 100, that is, for amplifying a signal for a specific receiving antenna and preventing signals transmitted to other receiving antennas, on the basis of the channel values of the uplink.

The distributor 430 receives uplink signals from terminals in a corresponding repetition area through the receiving antennas of the repeater 400, and distributes the signals as much as the number of transmitting/receiving antennas of the repeater 400.

The antenna selection multiplier 440 multiplies the signals distributed for the transmitting/receiving antennas by the distributor 430 by the coefficient vector created by the antenna selection vector generator 420, and outputs the results.

The amplifier 450 amplifies the strength of the signals outputted from the antenna selection multiplier 440, and then outputs the signals.

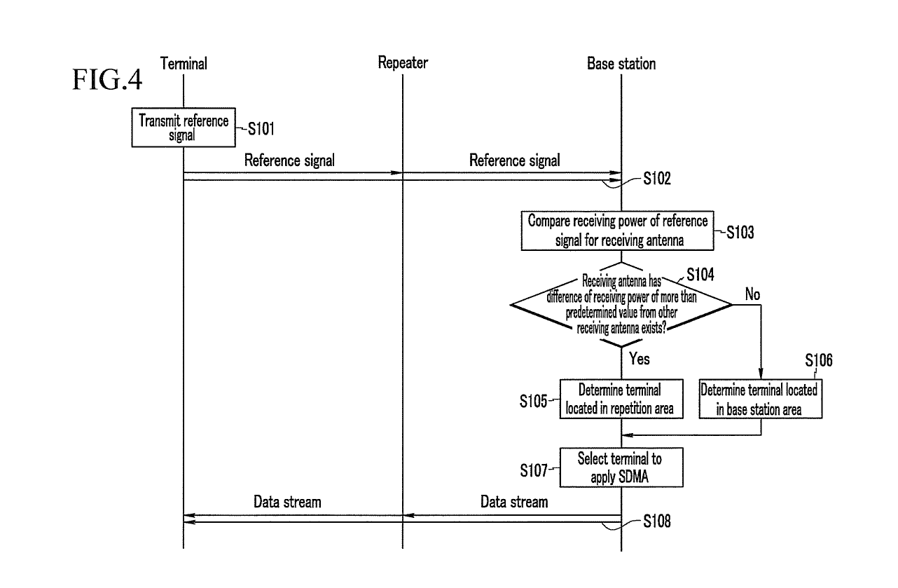

FIG. 4 is a flowchart illustrating a method of acquiring information on an area where terminals are located by a base station according to an exemplary embodiment of the present invention to apply the SDMA method, in which the base station directly acquires information on an area where terminals are located by using signals transmitted from the terminal.

Referring to FIG. 4, in order for the base station 100 to directly acquire information on the area where the terminals are located, in an exemplary embodiment of the present invention, corresponding terminals periodically or non-periodically transmit reference signals that the base station 100 can recognize to the uplink (S101), and the base station 100 receives the reference signals that are directly transmitted from the terminals through the multiple receiving antenna or that are amplified and transmitted through a repeater (S102). In this operation, the repeater receives, amplifies, and transmits the signals transmitted from the terminals in the corresponding repetition area to the base station 100 such that specific antennas of the base station 100 can receive the signals with the largest strength.

Thereafter, the base station 100 calculates receiving power for each of the receiving antennas of the base station 100 by using the received reference signals, and compares the calculated receiving power among the receiving antennas (S103). Further, it is determined whether there are receiving antennas having receiving power differences of more than a predetermined value from other receiving antennas in the receiving antennas of the base station 100 (S104).

When there are receiving antennas having receiving power differences of more than a predetermined value from other receiving antennas, the base station 100 determines that the terminals are located in a repetition region corresponding to the corresponding receiving antenna (S105). On the contrary, when the receiving power among the receiving antennas is smaller than the predetermined value, the base station 100 determines that the corresponding terminals are located in the base station area (S106).

Thereafter, the base station 100 selects terminals one by one that do not interfere with each other when transmitting data streams to the downlink for each repetition area to apply the SDMA method, by using the information on the area where the terminals are located (S107). Further, the base station 100 allocates resources such that the SDMA method can be applied to the selected terminals, and transmits or receives the data streams by using the allocated resources (S108).

As described above, the method in which the base station 100 acquires the information on the area where the corresponding terminals are located by using the reference signals received from the terminals enables the base station 100 to itself determine the area where the terminals are located, even if the information on the area is not fed back to the base station 100 from the terminals. Therefore, feedback overhead of the terminal is reduced.

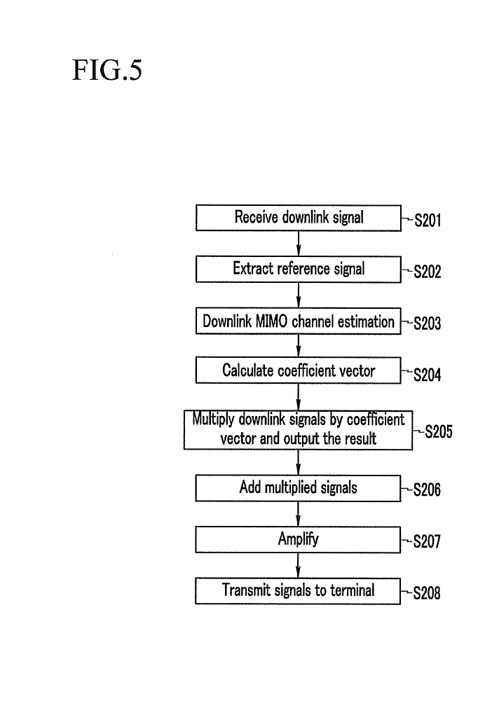

FIG. 5 is a flowchart illustrating a method in which the repeater 300 for a downlink repeats the signals transmitted by the base station 100 according to an exemplary embodiment of the present invention.

Referring to FIG. 5, the repeater 300 first receives the downlink signals transmitted from the base station 100 through a plurality of receiving antennas (S201), and extracts reference signals that will be used for estimating channels from the received downlink signals (S202). Further, acquisition of channel values of the downlink occurs by performing downlink MIMO channel estimation, using the reference signals extracted through the channel estimator 310 (S203). The method of performing the downlink MIMO channel estimation is well known and can be easily implemented by those skilled in the art, so a detailed description is not provided.

Thereafter, the repeater 300 calculates a coefficient vector that is used for select a receiving antenna through which a signal is repeated by the repeater 300 in the receiving antennas of the base station 100, by using the channel values outputted from the channel estimator 310 through the antenna selection vector generator 320, as follows (S204).

First, the downlink channel values “H” between the plurality of transmitting antennas of the base station 100 that are estimated by the channel estimator 310 and the plurality of receiving antennas of the repeater 300 can be expressed by the following Equation 1.

$$H = [ \begin{matrix}{h}_{11} & {h}_{12} & … & {h}_{1 N} \\ {h}_{21} & {h}_{22} & … & {h}_{2 N} \\ ⋮ & ⋮ & … & ⋮ \\ {h}_{M 1} & {h}_{M 2} & … & {h}_{MN}\end{matrix} ] \qquad ( Equation 1 )$$

Herein, M is the number of receiving antennas of the repeater 300, N is the number of transmitting antennas of the base station 100, and generally, M is the same as or larger than N. Further, hᵢⱼ is a channel value estimated between the i-th receiving antenna of the repeater 300 and the j-th transmitting antenna of the base station 100.

Meanwhile, a coefficient vector can be calculated by a minimum mean square error (MMSE) method, when the n-th transmitting antenna of the transmitting antennas of the base station 100 is selected for repetition, which can be expressed as the following Equation 2.

vₙ=hₙ^{H}(σ_{w}²I_{M}+HH^{H})⁻¹ (Equation 2)

Herein, hₙ is vector of the channel values between the n-th transmitting antenna of the base station 100 and the plurality of receiving antenna of the repeater 300. Further, the superscript “H” means transposition and a complex conjugate of a matrix or a vector, and σ_{w}² is noise power of the repeater 300.

Further, when the n-th transmitting antenna of the transmitting antennas of the base station 100 is selected for repetition, a coefficient vector can be calculated by zero forcing (ZF), which can be expressed by the following Equation 3.

vₙ=hₙ^{H}(HH^{H})⁻¹ (Equation 3)

As described above, when the coefficient vector is calculated, the repeater 300 multiplies the downlink signals received through the receiving antennas of the repeater 300 by the coefficient vector calculated by the antenna selection multiplier 330, and outputs the results (S205). Further, the signals multiplied by the coefficient vector and outputted by the adder 340 are added (S206), and the strength of the added signals are amplified and outputted on the basis of the coefficient vector to adjust the repetition area of the repeater 300 (S207).

Meanwhile, the transmitting antenna of the base station 100, which is an object of signal repetition of the repeater 300, is determined in advance in design of the system, or may be determined by the base station 100 or a control station by variably reporting it to the repeater 300 at a certain time by using control information. Further, it is possible to determine the transmitting antenna by applying a channel value that is acquired by channel estimation of the repeater 300 to a specific mathematical determination formula.

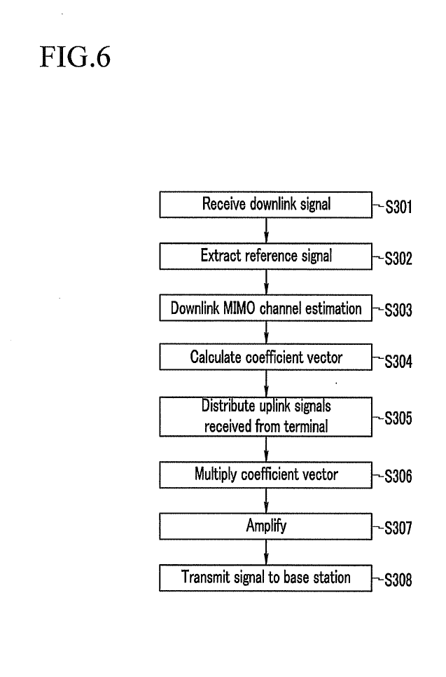

FIG. 6 is a flowchart illustrating a method of repeating a signal transmitted from a terminal by using the repeater 400 for an uplink according to an exemplary embodiment of the present invention, in which a TDD system is exemplified.

Referring to FIG. 6, the repeater 400 first receives a downlink signal transmitted from the base station 100 through a multiple transmitting/receiving antenna (S301), and extracts a reference signal that will be used for channel estimation from the received downlink signal (S302). Further, a channel value of the uplink is acquired by performing uplink MIMO channel estimation, by using the reference signal extracted by the channel estimator 410 (S203). Methods of performing the uplink MIMO channel estimation are well known and can be easily implemented by those skilled in the art, and a detailed description is not provided. Meanwhile, the method of acquiring a channel value is a method that is applied to the TDD system, and an uplink channel value is received from the base station 100 and used in the FDD system.

Thereafter, the repeater 400 creates a coefficient vector that is used to select a receiving antenna that will be used to transmit a signal by the repeater 400 from the plurality of receiving antennas of the base station 100, by using the channel value calculated by the antenna selection vector generator 420, as follows (S304).

First, a channel value “H” between the plurality of receiving antennas of the base station 100 and the multiple transmitting/receiving antenna of the repeater 400 that has been estimated by the channel estimator 410 can be expressed by Equation 1 described above. In the TDD system, channel reversibility exists, such that the downlink channel value of Equation 1 can be used as the uplink channel value.

Meanwhile, when the n-th receiving antenna of the receiving antennas of the base station 100 is used to repeat a signal, a coefficient vector can be calculated by the minimum mean square error (MMSE) method, which can be expressed by the following Equation 4.

vₙ=hₙ^{H}(σ_{w}²I_{M}+HH^{H})⁻¹ (Equation 4)

Herein, hₙ are vectors of the channels between the n-th receiving antenna of the base station 100 and the multiple antennas of the repeater 400. Further, the superscript “H” means transposition and a complex conjugate of a matrix or a vector, and σ_{w}² is noise power of the base station 100. It can be assumed that the noise power of the base station 100 is the same as the repeater 300, or is a predetermined value.

On the other hand, when the n-th receiving antenna of the receiving antennas of the base station 100 is used to repeat a signal, a coefficient vector can be calculated by the zero forcing (ZF) method, which can be expressed by the following Equation 5.

vₙ=hₙ^{H}(HH^{H})⁻¹ (Equation 5)

As described above, after the coefficient vector is calculated, when an uplink signal is received from a terminal in a corresponding repetition area, the repeater 400 distributes the signals for the multiple transmitting/receiving antenna of the repeater 400, using the distributor 430 (S305). The antenna selection multiplier 440 multiplies distributed signals for the multiple transmitting/receiving antenna with the calculated coefficient vector and then outputs the results (S306). Thereafter, the repeater 400 amplifies the signals multiplied by the coefficient vector by using the amplifier 450 and then transmits the signal to the base station 100 (S307).

Meanwhile, the receiving antenna of the base station 100, which is an object of signal repetition of the repeater 400, is determined in advance in system design, or may be determined by the base station 100 or a control station by variably reporting it to the repeater 400 at a certain time by using control information. Further, it is possible to determine the receiving antenna by applying a channel value that is acquired by channel estimation of the repeater 400 to a specific mathematical determination formula.

Meanwhile, in an exemplary embodiment of the present invention, although the MMSE method and the ZF method are exemplified as methods of calculating a coefficient vector, the present invention is not limited thereto and the present invention can calculate a coefficient vector for selecting an antenna using another method.

As described above, according to an exemplary embodiment of the present invention, the base station can determine a repetition area or a base station area where the terminal is located even if the terminal does not feed back information on the area, such that it is possible to reduce feedback overhead in the uplink.

Also, since the repeaters and the base station including multiple antennas are effectively combined, it is possible to increase sector capacity and make it possible to easily apply the SDMA method. Further, by using not wire, but wireless repeaters, it is possible to prevent additional expenses, such as rent for the optical line, while relatively freely selecting the installation place, thereby achieving an economical effect.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a repeater to repeat a signal transmitted from a base station including a plurality of transmitting antennas in a downlink by using a spatial division multiplexing access method, comprising:
estimating channel values of the downlink by using downlink signals received from the base station through a plurality of receiving antennas;
calculating coefficient vectors for selecting one of the plurality of transmitting antennas by using the channel values;
multiplying the downlink signals received by the plurality of receiving antennas by the coefficient vectors and outputting the results;
outputting one signal by adding the down signals multiplied by the coefficient vectors; and
amplifying the outputted signal and transmitting the same to a terminal located in a repetition area of the repeater.

2. The method of repetition of claim 1, wherein the estimating of channel values comprises calculating channel values between the plurality of transmitting antennas and the plurality of receiving antennas by performing downlink multiple input multiple output channel estimation using reference signals included in the downlink signals.

3. The method of repetition of claim 1, wherein the calculating of coefficient vectors comprises generating the coefficient vector to amplify a signal of a transmitting antennal that is used for repetition by the repeater in the plurality of transmitting antennas and to prevent signals of the other antennas, except for the transmitting antenna that is used for repetition.

4. The method of repetition of claim 3, wherein the calculating of a coefficient vector comprises calculating the coefficient vector by using a minimum mean square error method.

5. The method of repetition of claim 3, wherein the calculating of a coefficient vector comprises calculating the coefficient vector by using a zero forcing method.

6. The method of repetition of claim 3, wherein the transmitting antenna that is used for repetition is determined in advance when the repeater is installed.

7. The method of repetition of claim 3, wherein the transmitting antenna that is used for repetition is determined on the basis of control information received from the base station or a control station.

8. A method for a repeater to repeat a signal transmitted from a terminal in a corresponding repetition area to a base station including a plurality of receiving antennas in an uplink by using a spatial division multiplexing access method, the method comprising:
calculating a coefficient vector for selecting one of the plurality of receiving antennas by using a channel value of the uplink;
distributing the uplink signals received from the terminal to a plurality of transmitting/receiving antennas;
multiplying the distributed signals by the coefficient vector and outputting the results;
amplifying the signals multiplied by the coefficient vector; and
transmitting the amplified signals to the base station by using the plurality of transmitting/receiving antennas.

9. The method of repetition of claim 8, further comprising creating a channel value of the uplink by performing uplink multiple input multiple output channel estimation using downlink signals received from the base station through the plurality of transmitting/receiving antennas.

10. The method of repetition of claim 8, further comprising receiving the channel value of the uplink from the base station.

11. A method in which a base station including a plurality of receiving antennas acquires information on an area where a terminal is located to implement a spatial division multiplexing access method by using a repeater, comprising:
directly receiving reference signals by the terminal through the plurality of receiving antennas, or receiving the reference signals amplified by a repeater;
calculating receiving power for the plurality of receiving antennas by using the reference signals; and
determining a repetition area or a base station area where the terminal is located by comparing the receiving power of the plurality of receiving antennas.

12. The method of repetition of claim 11, wherein the reference signal is a pilot signal or a ranging signal.

13. The method of repetition of claim 11, wherein the determining comprises determining that the terminal is included in the base station area, when a difference between the receiving power of the plurality of receiving antennas is smaller than a predetermined value.

14. The method of repetition of claim 11, wherein the determining comprises determining that the terminal is included in a repetition area corresponding to a receiving antenna having a difference of receiving power of more than the predetermined value from another antenna, when a receiving antenna has a difference of receiving power of more than the predetermined value from the another antenna in the plurality of receiving antennas.

15. The method of repetition of claim 11, wherein the receiving comprises receiving the reference signals processed by the repeater to be received with the largest strength by a specific receiving antenna of the plurality of receiving antennas.

16. The method of repetition of claim 11, wherein the repeater is a wire optical repeater that is independently connected one-to-one to a specific antenna of the plurality of receiving antennas, in the receiving.
